(19) United States
(12) Patent Application Publication
(10) Pub. No.: US 2025/0001895 A1
(43) Pub. Date: Jan. 2, 2025

(54) Transmission of Service Information From a Charging Station to an Electric Vehicle

(71) Applicant: Bayerische Motoren Werke Aktiengesellschaft, Muenchen (DE)

(72) Inventor: Mariano HERRERO, Muenchen (DE)

(21) Appl. No.: 18/697,583

(22) PCT Filed: Sep. 8, 2022
(86) PCT No.: PCT/EP2022/075005

§ 371 Date: Apr. 1, 2024

(30) Foreign Application Priority Data
Oct. 12, 2021 (DE) 10 2021 126 338.7

(51) Int. Cl. B60L 53/66; B60L 53/14

(52) U.S. Cl. CPC B60L 53/66; B60L 53/14

(57) ABSTRACT

A method includes transmitting information from a charging station for electric vehicles to an electric vehicle, the information comprising service information concerning an operator of the charging station. A charging station for charging an electric vehicle is designed to transmit information to the electric vehicle, the information comprising service information concerning an operator of the charging station. An electric vehicle is designed to receive information from a charging station, the information comprising service information concerning an operator of the charging station.

### BACKGROUND AND SUMMARY

The invention relates to a method for transmitting information from a charging station to an electric vehicle. The invention also relates to a charging station for charging an electric vehicle, wherein the charging station is configured to transmit information to the electric vehicle. The invention further relates to an electric vehicle that is configured to receive information from a charging station. The invention furthermore relates to a computer program product, comprising code that, when executed on a data processing apparatus, causes a charging station to transmit information from the charging station to an electric vehicle that is connected to the charging station for charging purposes. The invention is in particular advantageously applicable to charging stations equipped with a charging cable and/or electric vehicles able to be charged by means of a charging cable.

Before an electric vehicle is charged at a charging station, for example a public charging column, the electric vehicle is authenticated and authorized with the aid of data exchange with the charging station via a connected charging cable, and the charging power is subsequently negotiated between the electric vehicle and the charging station. Depending on charging standards, communication protocols such as DC Combo charging, ChaDeMO, GBT, etc. can be used for the data exchange. By way of example, the charging power depends on the state of charge of the battery of the electric vehicle, the properties and temperature of the battery, the power electronics in the electric vehicle, as well as many other parameters of the electric vehicle and the charging station. These parameters are exchanged between the electric vehicle and the charging column via the protocols mentioned above.

A charging operation frequently either cannot be started or is cut short. In such a case, it generally only remains for the customer to be guided by the fault reports that are displayed in the vehicle or at the charging station. Contact or service information of the operator of the charging station (e.g. a telephone number for a 24-hour hotline) are generally attached directly to the charging stations, e.g. as a sticker. However, it can become inconvenient for the customer to read this information. The customer thus has to go to the charging station for this purpose, e.g. has to get out of the car at night and/or in the rain or interrupt a coffee break if a notification concerning a charging termination is indicated via their smartphone, then look for the service information at the charging station and subsequently contact, e.g. call, the operator using the service information. There is also always the possibility that the sticker bearing the service information has been torn down or defaced in such a way that the service information is illegible.

It is also known for operators of charging stations to provide websites where service information is available. In order to obtain this service information, however, the user has to know the web address of the website, which is often not the case.

US 2015/0229458 A1 discloses an electric vehicle charging station and an electric vehicle. In one embodiment, a modem is connected to the pilot wire that couples the charging station and the electric vehicle. The modem transmits both pulse-width modulation (PWM) control signals and power line communication (PLC) signals to a remote device via the pilot cable. The modem interleaves the PWM and PLC signals on the pilot wire so that the latency requirements for the PWM signals are maintained. The modem supports parallel protocol stacks in which PLC signals are processed in a first path and PWM signals are processed in a second path that bypasses the first path and provides the PWM signals directly to a MAC layer. The modem may create a modified frame for the PLC signals so as to maintain the latency requirements.

US 2012/0146582 A1 discloses a charging control system for an electric vehicle. This includes a charge-monitoring device coupled to a battery system of an electric vehicle, a processor coupled to the charge-monitoring device, and a communication interface coupled to the processor. The charge-monitoring device may detect the charging conditions of an electrical charging operation provided from a charging device to the battery system in order to charge the battery system, and the processor may determine whether the charging conditions exceed a tolerance criterion associated with at least one charge-monitoring device, the battery system, and/or the electric vehicle. The communication interface may communicate to the charge-monitoring device, a charge-receiving device, and/or the charging device at least one of a charging instruction and a charging indication provided by the processor based on a determination of whether the charging conditions exceed the value, tolerance criteria or

U.S. Pat. No. 9,446,674 B2 discloses systems, methods and devices for communicating with a charging system comprising a plurality of charging stations configured to charge an electric vehicle. At least one first signal is transmitted to the charging system via a first communication link while the electric vehicle is at a first distance from at least one charging station of the plurality of charging stations. The at least one first signal is indicative of a vehicle identifier of the electric vehicle. At least one second signal is received from the at least one charging station of the plurality of charging stations via a second communication link while the electric vehicle is at a second distance from the at least one charging station, wherein the second distance is less than the first distance. The at least one second signal is indicative of a charging station identifier of the at least one charging station.

It is an object of the present invention to at least partially overcome the disadvantages of the prior art and in particular to provide an improved possibility for a user or customer of a charging station to be able to contact an operator of the charging station in the event of a fault in a charging operation in which, for example, a charging operation either is not started or is cut short.

This object is achieved according to the features of the present disclosure. Preferred embodiments can also be gathered in particular from the present disclosure.

The object is achieved by a method for transmitting information from a charging station to an electric vehicle, wherein the information comprises contact or service information concerning an operator of the charging station. This results in the advantage that, in the event of a fault in a charging operation, the service information is available in the vehicle and, for example, can be displayed there such that the customer can readily use it to make contact with the operator, for example by way of actuation of a touchscreen of the vehicle, iDrive or voice input.

By way of example, the electric vehicle can be a plug-in hybrid vehicle or a fully electrically driven vehicle. By way of example, the electric vehicle can be an automobile, a bus, a truck or a motorcycle, etc.

One configuration is that the service information is transmitted from the charging station to the electric vehicle via a charging cable. This allows particularly reliable data transmission, since data exchange via the charging cable is provided as such for modern charging systems in any case, and there is no need to resort to alternative communication channels such as radio, Bluetooth, etc., which are possibly not supported by the charging station and/or by the electric vehicle.

However, it is fundamentally also possible to transmit the service information from the charging station to the electric vehicle via radio, for example, mobile radio, Bluetooth, etc.

If the electric vehicle is able to be charged inductively, one development is that the service information is able to be transmitted to the electric vehicle by way of the inductive coupling between the charging station (charging point) and the electric vehicle, for example by way of amplitude and/or frequency modulation of the charging signal.

One configuration is that the service information is transmitted while communication is being established between the charging station and the electric vehicle. The service information is therefore advantageously available to the electric vehicle at an early stage.

One configuration is that the service information is transmitted in at least one field of a communication charging protocol that is provided for this purpose, for example within a header. This is particularly advantageous because the at least one field comprising the service information is reliably able to be found, in particular if the communication charging protocol is standardized in such a way. It is proposed, in particular, to extend the communication charging protocols in such a way that the service information of the operator is transmitted to the electric vehicle in the course of communication being established between the electric vehicle and the charging station.

One configuration is that the service information comprises at least one item of information from the group including service telephone number of the operator of the charging station (for example a service hotline); website of the operator of the charging station, in particular for reporting a fault; email address of the operator of the charging station; social media address of the operator of the charging station (for example WhatsApp number, or the like).

If the service telephone number of the operator is provided, one development is that the telephone number is displayed in the vehicle for the user in the event of a fault, such that the user can easily call the telephone number, for example using the touchscreen of the vehicle, iDrive or voice input.

One configuration is that, if the service information is an email address and/or a social media address and a corresponding message type is selected by the user to create a message to the operator of the charging station (for example an email or a WhatsApp message), a message template to the operator of the charging station is automatically created, which template comprises at least one item of information regarding the charging station and/or a charging operation. This makes it easier for the user to compose the message and for the operator of the charging station to localize and possibly eliminate faults. The user can add their own information to the template or leave the template unchanged before sending the message. They can also discard the message.

One configuration is that the information regarding the charging station and/or the charging operation comprises at least one item of information from the group including identifier of the charging station (for example EVSE-ID); geoposition of the charging station (for example GPS coordinates); time; fault report regarding the charging operation (for example comprising a fault ID), etc.

One configuration is that the service information is forwarded from the electric vehicle to a mobile user terminal, for example to a suitable application program (“App”). The advantage is therefore achieved that the user can contact the operator via their mobile user terminal without needing to be at the location of the electric vehicle for this purpose. By way of example, the mobile user terminal can be a smartphone, a tablet PC, a notebook PC, a laptop PC, etc. If the mobile user terminal is a smartphone, for example, this can be configured in such a way that a user can make a phone call to a service hotline with a simple click.

The object is also achieved by a charging station for charging an electric vehicle, wherein the charging station is configured to transmit information to the electric vehicle and wherein the information comprises service information concerning an operator of the charging station. The charging station can be designed analogously to the method, and vice versa, and has the same advantages.

By way of example, the charging station can therefore be configured in one configuration to transmit the service information to the electric vehicle via a charging cable connected to the electric vehicle.

The object is further achieved by an electric vehicle that is configured to receive information from a charging station, wherein the information comprises service information concerning an operator of the charging station. The electric vehicle can be designed analogously to the method, and vice versa, and has the same advantages.

By way of example, the electric vehicle can therefore be configured to receive the service information via a charging cable of a charging station connected thereto.

The electric vehicle can also be configured, upon receiving the service information and a fault report regarding a charging operation, to automatically provide the service information to a user for further use, for example to provide a telephone number for a hotline of the operator for dialing, for example using a touchscreen of the vehicle, iDrive, voice control, etc.

The object is moreover achieved by a system comprising at least one charging station as described above and at least one electric vehicle as described above.

The object is furthermore achieved by a computer program product, comprising code or instructions that, when executed on a data processing apparatus, causes/cause a charging station to transmit service information concerning an operator of a charging station from the charging station to an electric vehicle that is coupled for data purposes, and connected in particular for charging purposes, to the charging station.

The object is additionally achieved by a computer program product, comprising code that, when executed on a data processing apparatus of an electric vehicle, causes the electric vehicle to receive service information concerning an operator of the charging station from the charging station and to provide same for use by a user of the electric vehicle.

The above-described properties, features and advantages of this invention, and the manner in which they are achieved, will become clearer and more clearly understandable in conjunction with the following schematic description of an exemplary embodiment, which will be explained in more detail in conjunction with the drawings.

### BRIEF DESCRIPTION OF THE DRAWINGS

FIG. 1 shows an illustration of an electric vehicle connected to a charging station; and

FIG. 2 shows a possible communication sequence between the charging station and the electric vehicle from FIG. 1.

### DETAILED DESCRIPTION OF THE DRAWINGS

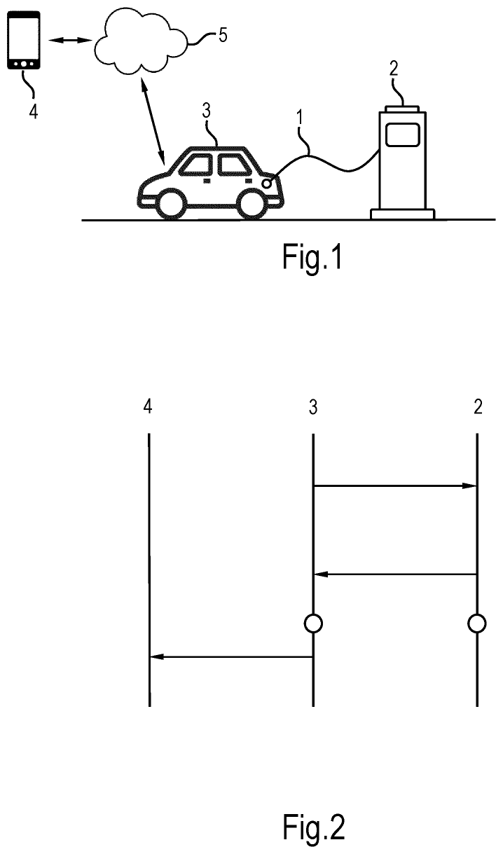

FIG. 1 shows an illustration of an electric vehicle 3 connected to a charging station 2 via a charging cable 1. The charging station 2 and the electric vehicle 3 can exchange information via the charging cable 1, for example respective identifiers, state of charge of the electric vehicle 3, etc. The data is transmitted by a communication protocol, in particular a communication charging protocol.

In this case, the communication charging protocol is extended in such a way that contact or service information concerning an operator of the charging station 2 is transmitted between the charging station 2 and the electric vehicle 3, in particular while communication is being established. By way of example, the service information can be transmitted in at least one field of the communication charging protocol that is provided for this purpose, for example in a header.

The electric vehicle 3 is additionally configured, in particular in the event of a fault in a charging operation that has not started or has been cut short, to forward the service information to a mobile user terminal 4, for example via a network 5 such as the Internet.

If the service information is an email address and/or a social media address and a corresponding message type is selected by a user to create a message to the operator of the charging station, a message template that is aimed at the operator of the charging station and comprises at least one item of information regarding the charging station and/or a charging operation, which, by way of example comprises an identifier of the charging station 2 (for example an EVSE ID), a geoposition of the charging station 2, a time and/or a fault report regarding the charging operation (for example a fault ID), is automatically created by the electric vehicle 3 and/or by the mobile user terminal 4 (for example by means of a correspondingly configured App).

FIG. 2 shows a possible communication sequence between the charging station 2 and the electric vehicle 3. In this case, after connection of the charging cable 1 in the course of communication being established, information concerning the electric vehicle 3 can initially be transmitted from the electric vehicle 3 to the charging station 2 via the charging cable 1, for example a state of charge of its battery, a battery capacity, payment information, etc. Subsequently, the charging station 2 transmits information to the electric vehicle 3 via the charging cable 1, for example regarding a charging capacity and additionally comprising the contact or service information concerning the operator of the charging station 2.

If, as indicated by the two circles, a fault occurs during charging, the electric vehicle 3 indicates the occurrence of the fault and the service information (for example on an on-board display). The user can then contact the operator via the electric vehicle 3. By way of example, if the service information comprises a telephone number, the electric vehicle 3 can be configured to immediately provide this telephone number to the user for dialling.

Furthermore, in the event of a fault, the electric vehicle 3 can report the occurrence of the fault to the mobile user terminal 4 of the user via the network 5 and can also send the service information. The user can then contact the operator via the mobile user terminal 4.

It goes without saying that the present invention is not limited to the exemplary embodiment shown.

### LIST OF REFERENCE SIGNS

1 Charging cable
2 Charging station
3 Electric vehicle
4 Mobile user terminal
5 Network

1-14. (canceled)

15. A method comprising:
transmitting information from a charging station for electric vehicles to an electric vehicle, wherein the information comprises service information concerning an operator of the charging station.

16. The method according to claim 15, comprising:
transmitting the service information from the charging station to the electric vehicle via a charging cable.

17. The method according to claim 15, comprising:
transmitting the service information while communication is being established between the charging station and the electric vehicle.

18. The method according to claim 15, comprising:
transmitting the service information in at least one field of a communication charging protocol that is provided for this purpose.

19. The method according to claim 15, wherein the service information comprises at least one of the following:
a telephone number of a hotline of an operator of the charging station;
a website of the operator of the charging station;
an email address of the operator of the charging station; and/or
a social media address of the operator of the charging station.

20. The method according to claim 19, wherein the service information is the email address and/or the social media address, the method comprising:
selecting a corresponding message type to create a message to the operator of the charging station; and
automatically creating a message template that is aimed at the operator of the charging station and comprises at least one item of information regarding the charging station and/or a charging operation.

21. The method according to claim 20, wherein the information regarding the charging station and/or the charging operation comprises at least one of the following:
an identifier of the charging station;
a geoposition of the charging station;
a time; and/or
a fault report regarding the charging operation.

22. The method according to claim 15, comprising:
forwarding the service information from the electric vehicle to a mobile user terminal.

23. A charging station for charging an electric vehicle, configured to:
transmit information to the electric vehicle, wherein the information comprises service information concerning an operator of the charging station.

24. The charging station according to claim 23, configured to:
transmit the service information to the electric vehicle via a charging cable connected to the electric vehicle.

25. The charging station according to claim 23, configured to:
transmit the service information while communication is being established between the charging station and the electric vehicle.

26. The charging station according to claim 23, configured to:
transmit the service information in at least one field of a communication charging protocol that is provided for this purpose.

27. The charging station according to claim 23, wherein the service information comprises at least one of the following:
a telephone number of a hotline of an operator of the charging station;
a website of the operator of the charging station;
an email address of the operator of the charging station; and/or
a social media address of the operator of the charging station.

28. An electric vehicle configured to:
receive information from a charging station, wherein the information comprises service information concerning an operator of the charging station.

29. The electric vehicle according to claim 28, wherein the electric vehicle is configured to receive the service information via a charging cable of a charging station connected thereto.

30. The electric vehicle according to claim 28, configured to:
receive the service information from the charging station while communication is being established between the charging station and the electric vehicle.

31. The electric vehicle according to claim 28, configured to:
receive the service information in at least one field of a communication charging protocol that is provided for this purpose.

32. The electric vehicle according to claim 28, wherein
the service information comprises at least one of the following:
an email address of the operator of the charging station; and/or
a social media address of the operator of the charging station, wherein the electric vehicle is configured to:
receive a selection of a corresponding message type to create a message to the operator of the charging station; and
automatically create a message template that is aimed at the operator of the charging station and comprises at least one item of information regarding the charging station and/or a charging operation.

33. The electric vehicle according to claim 32, wherein the information regarding the charging station and/or the charging operation comprises at least one of the following:
an identifier of the charging station;
a geoposition of the charging station;
a time; and/or
a fault report regarding the charging operation.

34. The electric vehicle according to claim 28, configured to:
forward the service information from the electric vehicle to a mobile user terminal.
